(19) United States
(12) Patent Application Publication
(10) Pub. No.: US 2025/0231550 A1
(43) Pub. Date: Jul. 17, 2025

(54) FCT/EOL CONTROLLER AND SYSTEM FOR AUTOMATED PRODUCTION LINE

(71) Applicants: Feilong Autoteil Company, Stock Limited, Nanyang (CN); Shanghai Feilong New Energy Autoteil Company, Limited, Shanghai (CN)

(72) Inventors: Jingzhong Wang, Shanghai (CN); Kai Sun, Nanyang (CN)

(21) Appl. No.: 18/944,006

(22) Filed: Nov. 12, 2024

(30) Foreign Application Priority Data
Jan. 16, 2024 (CN) 202410063703.2

(51) Int. Cl. G05B 19/418

(52) U.S. Cl. CPC G05B 19/41865; G05B 2219/31368

(57) ABSTRACT

The present invention relates to the technical field of controllers for automatic production lines, in particular to an FCT/EOL controller adapted to an automated production line and a system thereof. The controller includes a main control chip module, a power management module, a CAN communication module, a LIN communication module and a serial communication module; the system includes a digital multimeter current reading module, a program-controlled power control module, a host computer command module, a test function module and a host computer feedback module; the controller can be customized with a controller function, an internal communication protocol and a control logic according to the requirements of production lines, and core data not to be disclosed.

### CROSS REFERENCE TO RELATED APPLICATIONS

The present application claims the benefit of Chinese Patent Application No. 202410063703.2 filed on Jan. 16, 2024, the contents of which are incorporated herein by reference in their entirety.

### FIELD OF THE INVENTION

The present invention relates to the technical field of controllers for automatic production lines, in particular to an FCT/EOL controller adapted to an automated production line and a system thereof.

### BACKGROUND OF THE INVENTION

At present, most of automated production lines put into production by manufacturers are concurrently provided with controllers by such kind of suppliers, but these equipment suppliers will ask the manufacturers to provide relevant information, so that they can make a controller. During this, both the parties also need to communicate data information specially in detail, after finishing making the controller, they still need to debug it together to confirm whether its function meets their requirements. The automated controllers in the prior art have the following deficiencies. 1. Disclosure of confidential information; 2. Increase in communication costs; 3. Increase in equipment costs for production lines; 4. Inconvenience for late-stage optimization and upgrading; 5. Increase in costs of late-stage optimization and upgrading. Therefore, it is of great significance to develop an FCT/EOL controller and a system for automated production lines.

### SUMMARY OF THE INVENTION

The objective of the present invention is to provide an FCT/EOL controller adapted to an automated production line and a system thereof for the problem existing in the prior art, which enable the controller to be customized with a controller function, an internal communication protocol and a control logic according to the requirements of production lines, and core data not to be disclosed.

The technical solution of the present invention is as follows.

An FCT/EOL controller adapted to an automated production line includes a main control chip module, a power management module, a CAN communication module, a LIN communication module and a serial communication module; wherein the main control chip module is used to burn and control programs; the CAN communication module is used to burn and communicate with compatible programs, externally connect with a product to perform a CAN communication control and receive and send data; the LIN communication module is connected with a product communicating with LIN for a test; the serial communication module is connected with a program-controlled power supply and a digital multimeter to control voltage changes of the power supply, so as to perform an over-under-voltage test and read current value information from a device under test; the power management module is used to supply electricity to other modules.

Specifically, the controller further includes a relay control module, which is used to switch and control other products or devices on the production line.

Specifically, the CAN communication module includes three CAN communication routes, one CAN communication route is compatible with programming and communicating with programs, and the other two CAN communication routes externally connect with a product to perform a CAN communication control and send and receive data.

Specifically, the serial communication module includes two serial communication routes, one serial communication route is connected with a program-controlled power supply of the production line, controls voltage changes of the power supply and perform an over-undervoltage test; the other serial communication route is connected with a digital multimeter of the production line, and reads current value information from a device under test.

A system of an FCT/EOL controller adapted to an automated production line includes a digital multimeter current reading module, a program-controlled power control module, a host computer command module, a test function module and a host computer feedback module; wherein the digital multimeter current reading module receives current information sent by a digital multimeter through a serial port by way of connecting with an ID instruction of a CAN communication module, converts serial port information and CAN communication in a circuit, and only receives and extracts a numerical value related to current in software; the program-controlled power control module sends the control name of current and voltage to a program-controlled power supply through a serial port by means of an ID instruction of the CAN communication module, converts serial port information and CAN communication in a circuit, and uses Stateflow in software to write instructions for an over-undervoltage test through Stateflow to realize the function of automatically cyclically testing over-undervoltage; the host computer command module receives a control instruction sent by a host computer by means of an ID instruction of the CAN communication module according to a communication protocol, and after receiving a corresponding control instruction, a program starts a corresponding function module to control a device under test to perform corresponding action, and then completes corresponding project operation; the test function module has a corresponding control instruction and test function; the host computer feedback module receives the information sent by the test function module, and feeds back ID to the host computer by means of CAN communication according to a communication protocol after pooling and processing.

Specifically, the system further includes a relay control module, and the relay control module controls switching of a relay, acting as a switch.

Specifically, the test function module includes an over-undervoltage state feedbacking module, a quiescent current control module, a minimum working current control module, a forward-backward rotation testing control module, a pre-assembled position switching control module, an EOL test control module, a product serial number writing control module and a manually-testing control module, of which each has a corresponding control instruction and test function.

The present invention has the following beneficial effect. The controller provided by the present invention mainly includes 6 modules, which are a main control chip module, a power management module, a CAN communication module, a LIN communication module, a serial communication module and a relay control module. It is possible to customize controller function according to the requirements of production lines; it is unnecessary to disclose internal communication protocols, control logic and core data; reducing communication costs makes it unnecessary to spend a lot of time to explain outwards, and raises the efficiency of internal communication; it is achievable to reduce costs of devices in production lines, and it is convenient for subsequent optimization and upgrading. The controller system provided by the present invention is built with Simulink module and Stateflow in its entirety, so it is more convenient and simpler than writing in C language or other programming languages. One can select all parts involved in the controller of the present invention by himself/herself to achieve the purpose of controlling costs; in addition, the product under test is also independently developed, so he/she can also internally complete the debugging between the controller and the product under test, such way is more efficient and diminishes communication with the outside, and on a problem, it is possible to immediately check and solve it.

### BRIEF DESCRIPTION OF THE DRAWINGS

FIG. 1 shows a principle block diagram of the controller according to the present invention.

FIG. 2 shows a circuit structure diagram of the power management module.

FIG. 3 shows a circuit structure diagram of the CAN communication module.

FIG. 4 shows a circuit structure diagram of the LIN communication module.

FIG. 5 shows a circuit structure diagram of the serial communication module.

FIG. 6 shows a circuit structure diagram of the relay control module.

FIG. 7 shows a circuit structure diagram of the digital multimeter current reading module.

FIG. 8 shows a circuit structure diagram of the program-controlled power control module.

FIG. 9 shows a circuit structure diagram of the host computer command module.

FIG. 10 shows a circuit structure diagram of the test function module.

### DETAILED DESCRIPTION OF SOME EMBODIMENTS

We shall describe in detail the technical solution of the present invention in combination with the drawings and examples as follows.

### EXAMPLE 1

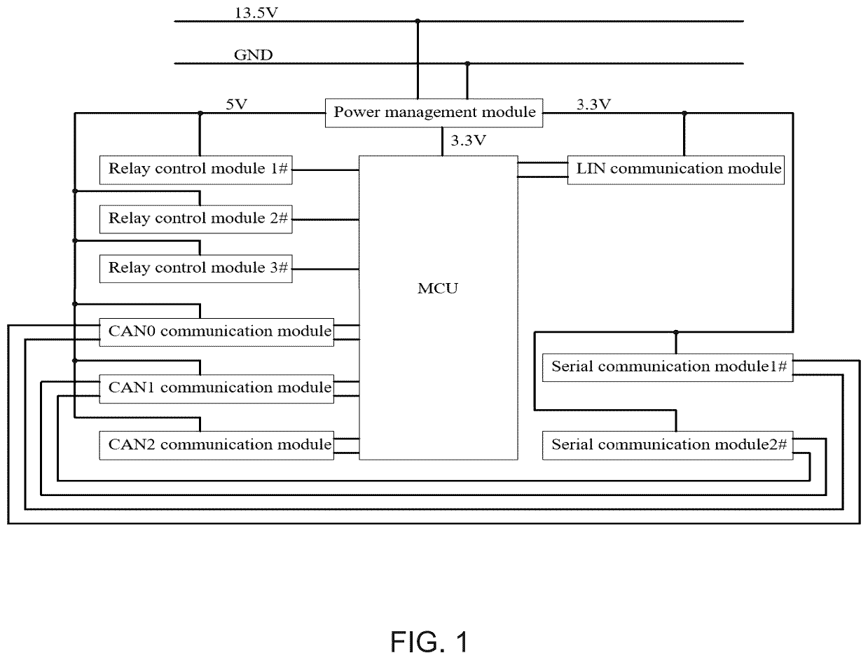

FIG. 1 shows a principle block diagram of the FCT/EOL controller adapted to an automated production line provided by this example. The controller includes a main control chip module, a power management module, a CAN communication module, a LIN communication module and a serial communication module; wherein the main control chip module is used to burn and control programs; the CAN communication module is used to burn and communicate with compatible programs, externally connect with a product to perform a CAN communication control and receive and send data; the LIN communication module has one LIN communication route connected with a product communicating with LIN for a test.

The serial communication module includes two serial communication routes, one serial communication route is connected with a program-controlled power supply of the production line, controls voltage changes of the power supply and perform an over-undervoltage test; the other serial communication route is connected with a digital multimeter of the production line, and reads current value information from a device under test.

The power management module can provide stable outputs of 3.3V and 5V for supplying electricity to other modules.

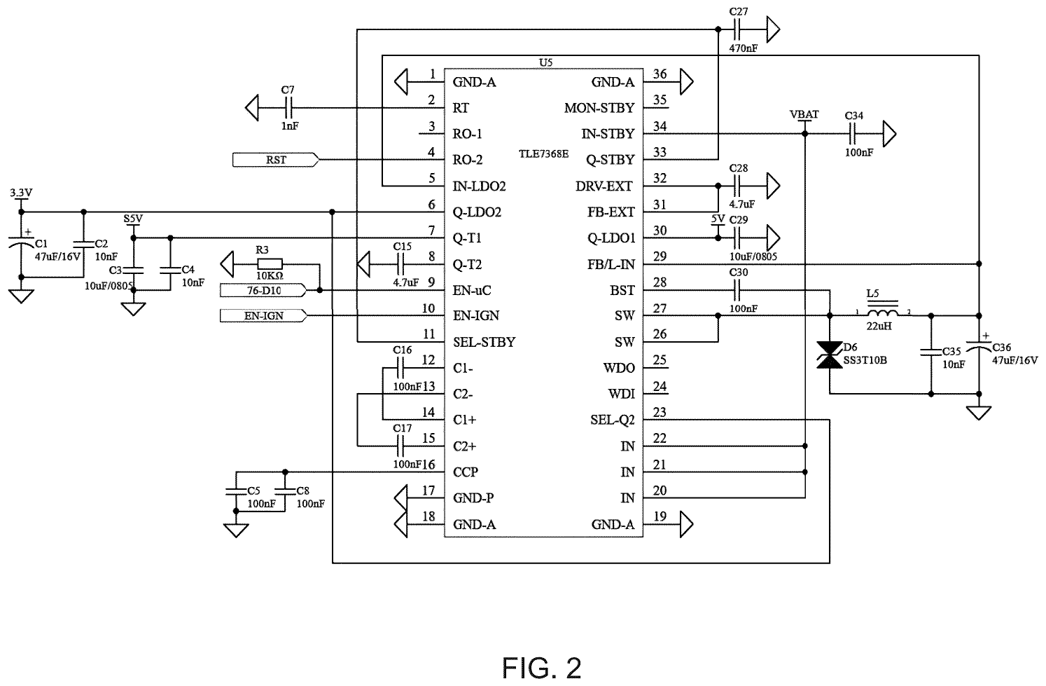

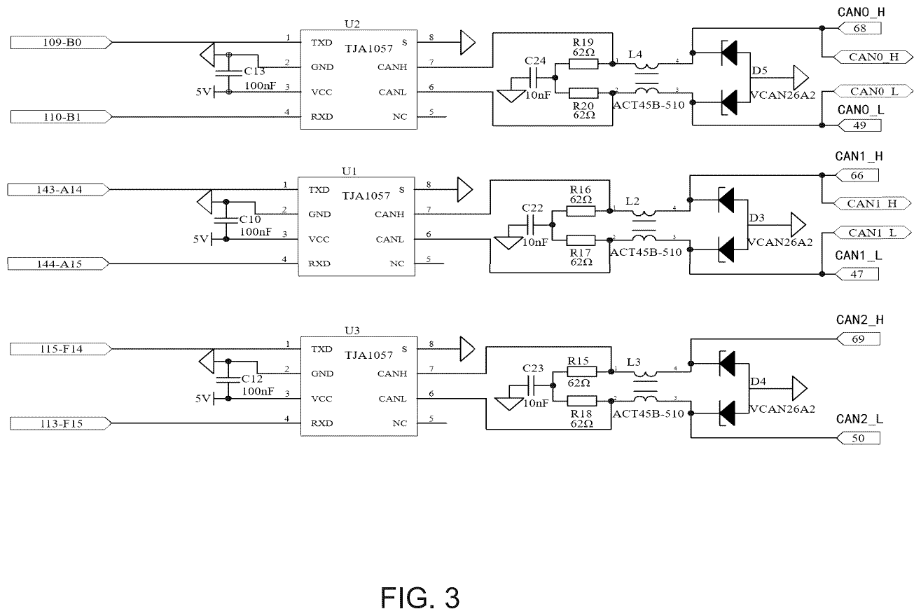

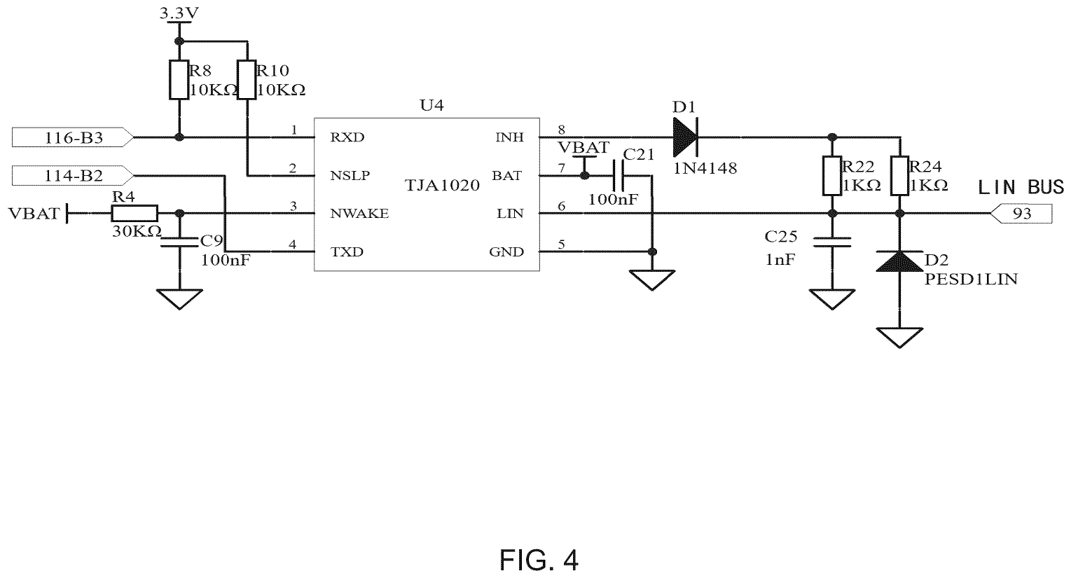

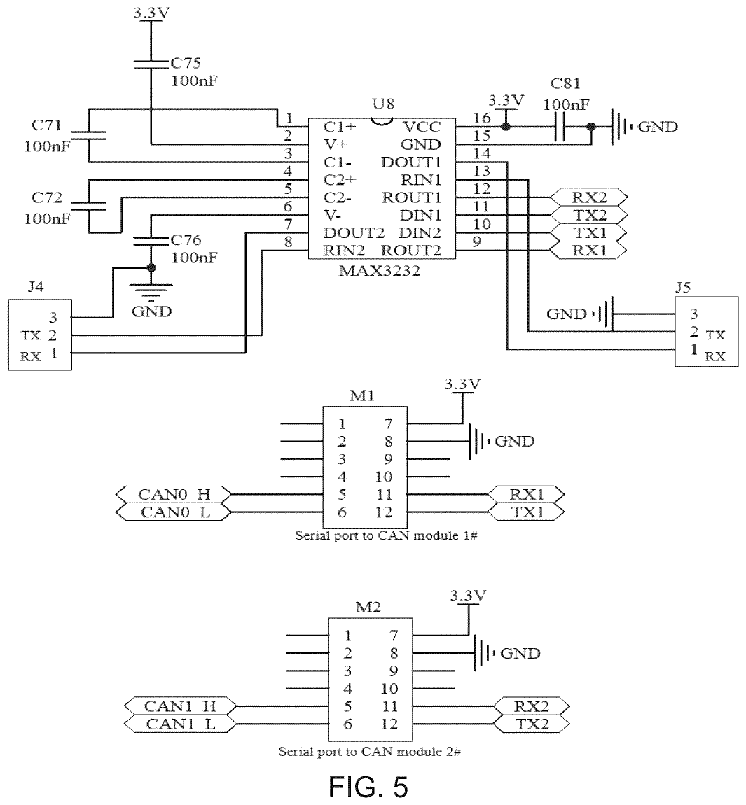

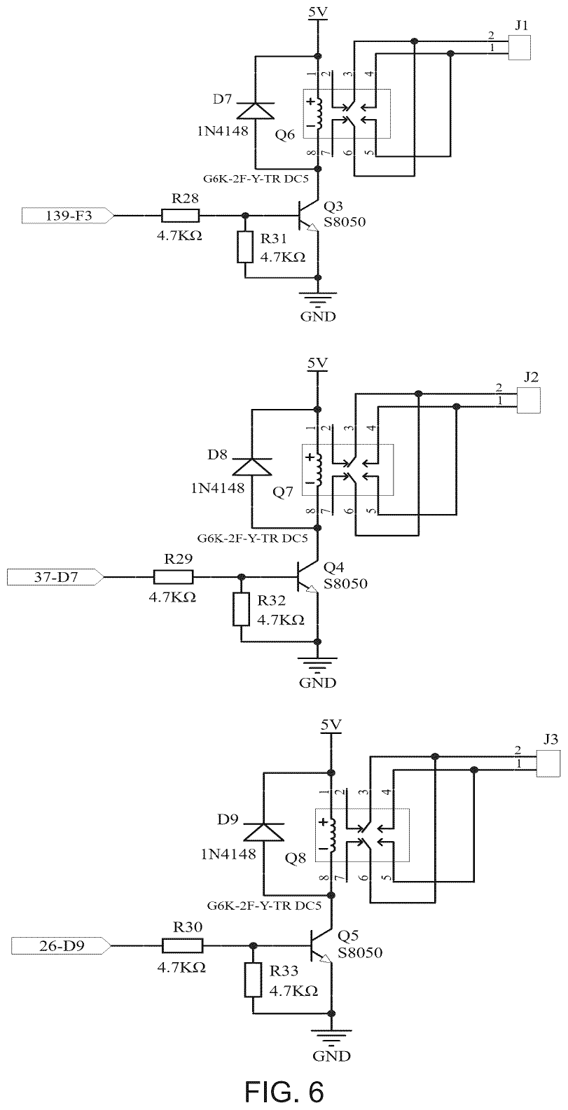

According to the actual needs, the controller may further include a relay control module, which is used to switch and control other products or devices on the production line as a reserved functional module. FIGS. 2-6 show circuit diagrams of each module.

The CAN communication module includes three CAN communication routes, one CAN communication route is compatible with programming and communicating with programs, and the other two CAN communication routes externally connect with a product to perform a CAN communication control and send and receive data.

The controller provided by this example mainly has four key technical points.

### 1. The Controller is Communicationally Connected With the Digital Multimeter.

It is critical to make a proper communicational connection between the controller and the digital multimeter on the production line, because it is necessary to read the current value of the product under test in real time, and ensure that the current value is read correctly and no delay in reception. A RS232 serial port is used to make an interconnection between the controller and the digital multimeter, which belongs to serial port communication, but CAN communication within the controller, so it needs a circuit that converts serial port signals to CAN signals, functioning as a converter converting ASCII codes into hexadecimal numbers.

### 2. The Controller is Communicationally Connected With the Program-Controlled Power Supply.

It is critical to make a proper communicational connection between the controller and the program-controlled power supply on the production line, because the tested product is electrified from the program-controlled power supply, furthermore an over-undervoltage test also needs to be adjusted by the program-controlled power supply. A RS232 serial port is used to make an interconnection between the controller and the program-controlled power supply, which belongs to serial port communication, but CAN communication within the controller, so it needs a circuit that converts serial port signals to CAN signals, functioning as a converter converting ASCII codes into hexadecimal numbers.

### 3. The Controller is Communicationally Connected With the Product.

It is critical to make a proper communicational connection between the controller and the product and make a correct action following an instruction set in the program. There is a LIN communication connection between the controller and the product, and each control instruction involves a plurality of specific operations of sending and receiving ID, while the LIN bus cannot concurrently execute two or more ID instructions, only execute the instructions one by one; therefore, it is necessary to enable a corresponding ID instruction to be executed in proper order through program settings, so this part of the function is executed through a delay module and a Stateflow module.

### 4. PCB Design and PCBA Functional Debugging

It is critical to make a reasonable layout and circuit arrangement on the PCB, which are the body of the controller, and it is necessary to reasonably design and distribute positions of each circuit and positions of each interface following the layout of the production line, so as to make it easy subsequently to interconnect and arrange wiring between the devices of the entire production line. For signal lines, power lines and other lines in the circuit, it needs to make a circuit arrangement according to the requirements of the PCB design, otherwise the function may be affected, resulting in unsuccessful functional debugging.

### EXAMPLE 2

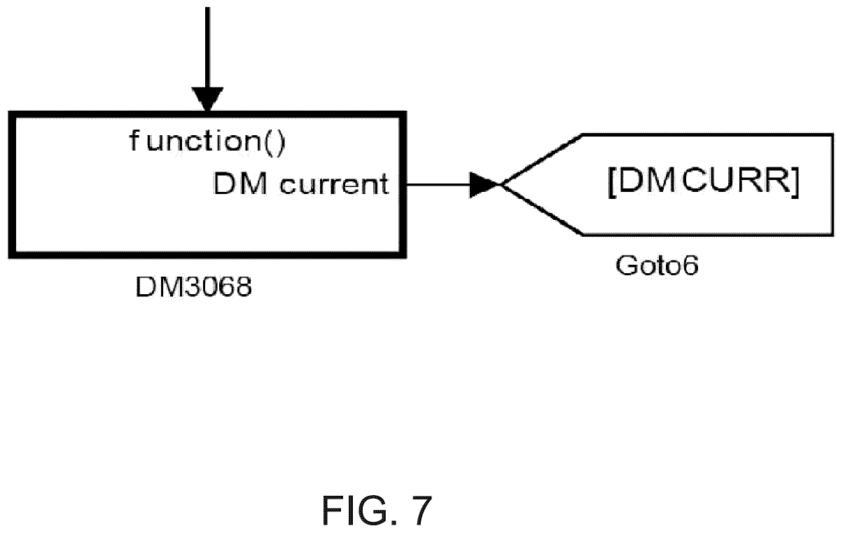

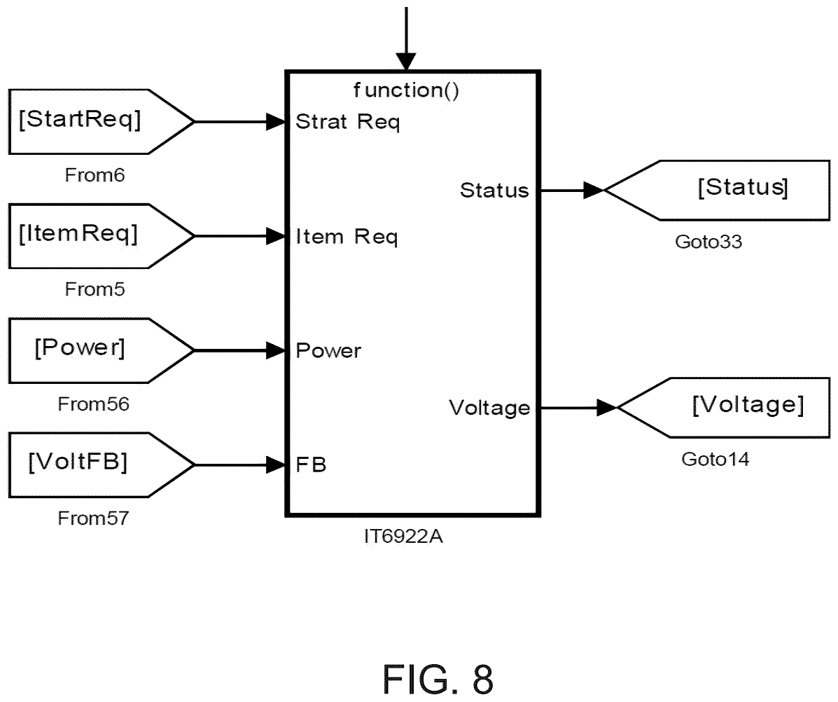

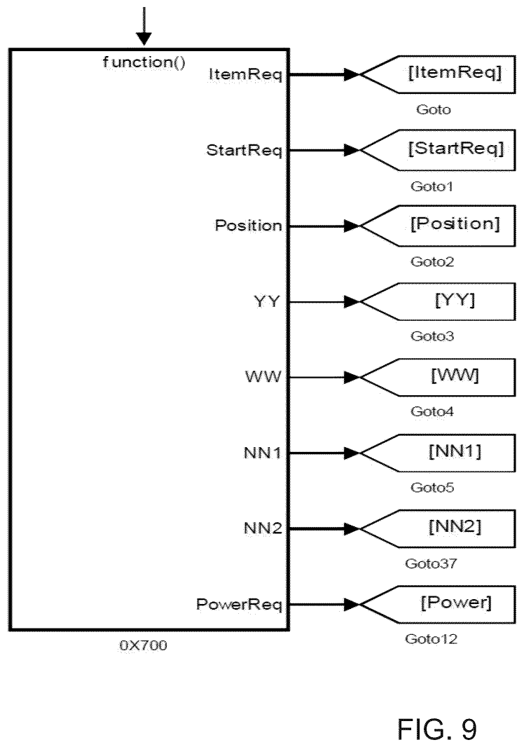

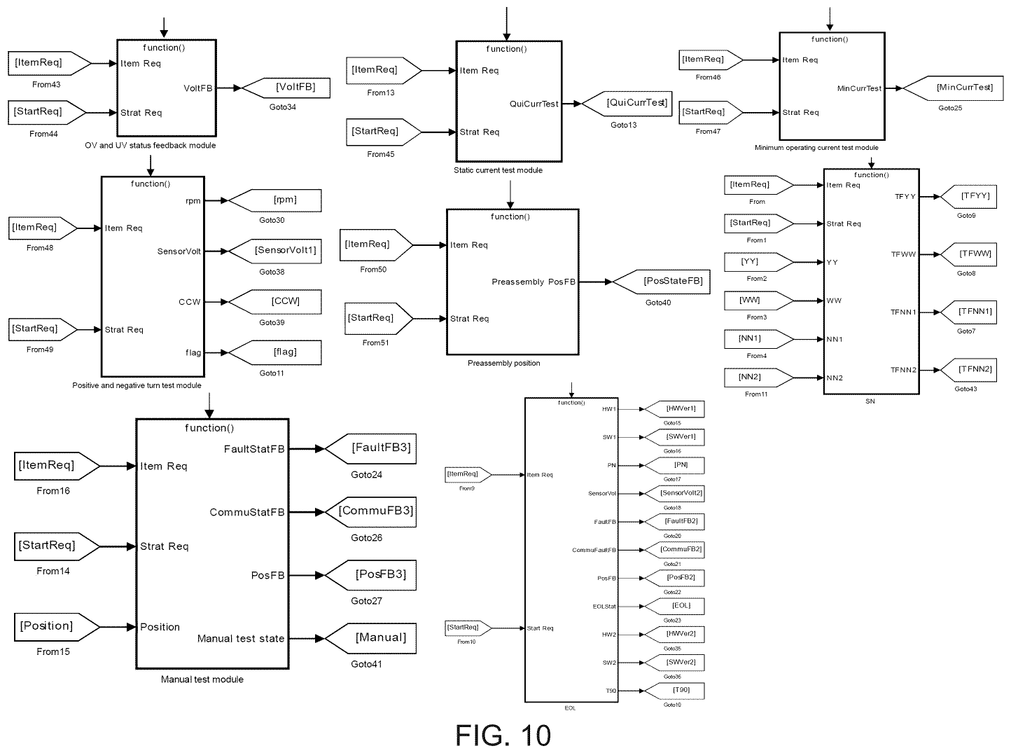

A system of an FCT/EOL controller adapted to an automated production line provided by this example includes a digital multimeter current reading module, a program-controlled power control module, a host computer command module, a test function module and a host computer feedback module; the circuit structure diagrams of the digital multimeter current reading module, the program-controlled power control module, the host computer command module and the test function module are shown in FIGS. 7-10. The digital multimeter current reading module receives current information sent by a digital multimeter through a serial port by way of connecting with ID instructions of 2 CAN communication modules, converts serial port information and CAN communication in a circuit, and only receives and extracts a numerical value related to current in software; the program-controlled power control module sends the control name of current and voltage to a program-controlled power supply through a serial port by means of ID instructions of 16 CAN communication modules, converts serial port information and CAN communication in a circuit, and uses Stateflow in software to write instructions for an over-undervoltage test through Stateflow to realize the function of automatically cyclically testing over-undervoltage; the host computer command module receives a control instruction sent by a host computer by means of an ID instruction of one CAN communication route according to a communication protocol, and after receiving a corresponding control instruction, a program starts a corresponding function module to control a device under test to perform corresponding action, and then completes corresponding project operation; the test function module has a corresponding control instruction and test function; the host computer feedback module receives the information sent by the test function module, and feeds back ID to the host computer by means of 7 CAN communication routes according to a communication protocol after pooling and processing.

According to the actual needs, the controller may further include a relay control module, and the relay control module controls switching of a relay, acting as a switch.

The test function module includes an over-undervoltage state feedbacking module, a quiescent current control module, a minimum working current control module, a forward-backward rotation testing control module, a pre-assembled position switching control module, an EOL test control module, a product serial number writing control module and a manually-testing control module, of which each has a corresponding control instruction and test function.

Finally, it should be noted that the above examples are only used to explain the technical solution of the present invention, but not to limit it; although the present invention is described in detail with reference to better embodiments, a person skilled in the art should understand that modifications may still made on the embodiments of the present invention or equivalent substitutions may made on some technical features, but they shall be contained in the protection scope of the technical solution claimed in the present invention, without departing from the essence of the technical solution of the present invention.

What is claimed is:

1. An FCT/EOL controller adapted to an automated production line comprising:
a main control chip module used to burn and control programs;
a CAN communication module used to burn and communicate with compatible programs, externally connect with a product to perform a CAN communication control and receive and send data;
a LIN communication module connected with a product communicating with LIN for a test;
a serial communication module connected with a program-controlled power supply and a digital multimeter to control voltage changes of the power supply, so as to perform an over-under-voltage test and read current value information from a device under test; and
a power management module used to supply electricity to other modules.

2. The FCT/EOL controller adapted to an automated production line according to claim 1, wherein the controller further includes a relay control module, which is used to switch and control other products or devices on the production line.

3. The FCT/EOL controller adapted to an automated production line according to claim 1, wherein said CAN communication module includes three CAN communication routes, one CAN communication route is compatible with programming and communicating with programs, and the other two CAN communication routes externally connect with a product to perform a CAN communication control and send and receive data.

4. The FCT/EOL controller adapted to an automated production line according to claim 1, wherein said serial communication module includes two serial communication routes, one serial communication route is connected with a program-controlled power supply of the production line, controls voltage changes of the power supply and perform an over-undervoltage test; the other serial communication route is connected with a digital multimeter of the production line, and reads current value information from a device under test.

5. A system of an FCT/EOL controller adapted to an automated production line comprising:
a digital multimeter current reading module that receives current information sent by a digital multimeter through a serial port by way of connecting with an ID instruction of a CAN communication module, converts serial port information and CAN communication in a circuit, and only receives and extracts a numerical value related to current in software;
a program-controlled power control module that sends the control name of current and voltage to a program-controlled power supply through a serial port by means of an ID instruction of the CAN communication module, converts serial port information and CAN communication in a circuit, and uses Stateflow in software to write instructions for an over-undervoltage test through Stateflow to realize the function of automatically cyclically testing over-undervoltage;
a host computer command module that receives a control instruction sent by a host computer by means of an ID instruction of the CAN communication module according to a communication protocol, and after receiving a corresponding control instruction, enables a program to start a corresponding function module to control a device under test to perform corresponding action, and then completes corresponding project operation;
a test function module that has a corresponding control instruction and test function; and
a host computer feedback module that receives the information sent by said test function module, and feeds back ID to the host computer by means of CAN communication according to a communication protocol after pooling and processing.

6. The system of an FCT/EOL controller adapted to an automated production line according to claim 5, wherein the system further includes a relay control module, and said relay control module controls switching of a relay, acting as a switch.

7. The system of an FCT/EOL controller adapted to an automated production line according to claim 5, wherein said test function module includes an over-undervoltage state feedbacking module, a quiescent current control module, a minimum working current control module, a forward-backward rotation testing control module, a pre-assembled position switching control module, an EOL test control module, a product serial number writing control module and a manually-testing control module, of which each has a corresponding control instruction and test function.
